(19) United States
(12) Patent Application Publication
(10) Pub. No.: US 2021/0036870 A1
(43) Pub. Date: Feb. 4, 2021

(54) METHOD AND INTEGRATED CIRCUIT FOR UPDATING A CERTIFICATE REVOCATION LIST IN A DEVICE

(71) Applicant: NXP B.V., Eindhoven (NL)

(72) Inventor: ALICIA DA CONCEICAO, Burnaby (CA)

(21) Appl. No.: 16/526,361

(22) Filed: Jul. 30, 2019

(51) Int. Cl. H04L 9/32; G06F 21/57

(52) U.S. Cl. CPC H04L 9/3268; G06F 21/57

(57) ABSTRACT

An authentication integrated circuit and a method for updating a revocation list in a host device are provided. The method includes storing a subset of a master revocation list in each of a plurality of replaceable accessories. Each of the replaceable accessories stores a different subset of the master revocation list. Communication is established between the host device and a replaceable accessory of the plurality of replaceable accessories. The host device verifies a certificate of the replaceable accessory. After verification, the host device compares the subset of the master revocation list with the revocation list of the host device to determine if the subset of the master revocation list includes a new entry. The new entry is included with the revocation list of the host device.

### BACKGROUND

### Field

This disclosure relates generally to electronic circuits and more specifically to a method and integrated circuit for updating a certificate revocation list in a device.

### Related Art

Many devices such as printers and electronic cigarettes use replaceable cartridges for consumables. For example, when an ink cartridge in a printer runs out of ink, one option is to replace the empty ink cartridge with a full ink cartridge. Authentication of the replaceable accessories is becoming increasingly necessary to prevent counterfeiting, fraud, damages, and potential liability of unsafe replaceable accessories. The use of authentication integrated circuits (ICs) in replaceable accessories is one way to make counterfeiting more difficult for an attacker. However, there is a risk that the security of replaceable accessories can be compromised, especially because there may be strong financial incentives. The compromised replaceable accessories can be counterfeited, and possibly malicious or unsafe accessories may be used with a host device.

A revocation list may be used by a host device to check if a replaceable accessory has been blacklisted as being untrustworthy. However, because many devices do not have an expiration date, and are not regularly connected to the internet, updating a revocation list in host devices may be difficult.

Therefore, a need exists for a method to update revocation lists for devices that use replaceable accessories.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates a system in accordance with an embodiment.

FIG. 2 illustrates, in block diagram form, an authentication IC of a replaceable accessory of the system of FIG. 1 in accordance with an embodiment.

FIG. 3 illustrates, in block diagram form, an authentication IC of a replaceable accessory of the system of FIG. 1 in accordance with another embodiment.

FIG. 4 illustrates a sequence diagram of a method for updating a revocation list in a host device of the system of FIG. 1 in accordance with an embodiment.

FIG. 5 illustrates a sequence diagram of a method for updating a revocation list in a host device of the system of FIG. 1 in accordance with another embodiment.

FIG. 6 illustrates a first embodiment for securing a revocation list subset in a non-volatile memory of the IC of FIG. 2 or FIG. 3.

FIG. 7 illustrates a second embodiment for securing a revocation list subset in a non-volatile memory of the IC of FIG. 2 or FIG. 3.

### DETAILED DESCRIPTION

Generally, there is provided, a system having a host device and a plurality of replaceable accessories for use in the host device, wherein each of the replaceable accessories includes an authentication integrated circuit (IC) used by host devices to cryptographically authenticate the replaceable accessory by using secret/private key operations performed by the accessory. A method is provided for the distributing offline, or updating offline, an authenticated revocation list in the host device using the replaceable accessories. A master revocation list of all known revoked accessories, which may change over time is generated by centralized entities and is divided up into one or more subsets of revocation entities based on the amount of available storage in the authentication ICs used. Different subsets may be discrete or may overlap. The authentication ICs are then factory provisioned with the revocation subsets so that every revocation entry has at least one authentication IC provisioned with it. Each authentication IC is also provisioned with certificate(s) that contain, at a minimum, public keys corresponding to the unique secret/private keys and digital signatures. The certificates may also contain many other possible value(s), including: serial numbers, unique identifiers (UIDs), attributes, extensions, validity, and versioning. Furthermore, each authentication IC has one or more digital signatures of each revocation subset with some value(s) in a signed certificate provisioned to the same authentication IC, such as the corresponding public key, serial number, unique identifier, attribute(s), and/or extension(s). These digital signatures also provide the means to bind the revocation subsets with the certificates of the same authentication ICs they are provisioned to.

When a replaceable accessory is in communication with the host device, the host device cryptographically validates the replaceable accessory by first validating the authentication IC certificate(s) and any revocation subset(s) that are present. Then, the authentication IC validates any associated secret/private keys.

After validation of each revocation subset, any new revocation list entries in the subset that are not in the host device's revocation list are merged in, thus updating the revocation list of the host device. Each time a new replaceable accessory is connected to the host device, the same method is used to check the revocation list portion of the new replaceable accessory. This approach allows for the offline distribution of many revocation entries using the plurality of replaceable accessories to provide increased coverage of known illegitimate accessories.

In accordance with an embodiment, there is provided, in a system comprising a host device and a plurality of replaceable accessories, a method for updating a revocation list in the host device, the method including: storing a certificate in each replaceable accessory of the plurality of replaceable accessories; storing a subset of a master revocation list in each of the plurality of replaceable accessories; establishing communication between the host device and a replaceable accessory of the plurality of replaceable accessories; verifying, by the host device, a certificate of the replaceable accessory; comparing, by the host device, the subset of the master revocation list with the revocation list of the host device; verifying by the host device that the subset of the master revocation list has a legitimate signature and corresponds to the certificate; determining, by the host device, that the subset of the master revocation list includes a new entry; and merging the new entry with the revocation list of the host device. Storing a subset of a master revocation list in each of the plurality of replaceable accessories may further include storing the subset of the master revocation list and a corresponding certificate in a memory location of an authentication integrated circuit in each of the plurality of replaceable accessories. The method may further include storing the subset of the master revocation with a signature in the memory location, wherein the subset may be bound to a value of the certificate in the replaceable accessory. Verifying, by the host device, a certificate of the replaceable accessory may further include checking that the certificate is not listed on the revocation list of the host device. The replaceable accessory may include one of either a printer ink/toner replacement cartridge, a 3D printer filament cartridge/spool, an electronic cigarette replacement cartridge, a beverage pod, a replacement filter element for a filtering apparatus, a sensor for a medical device, a refill cartridge for a medicine delivery system, a battery, a battery charger, and other replaceable accessory connected to and used by a longer lasting host device. The method may further include verifying a revocation list signature to establish the authenticity of the subset of the master revocation list prior to the step of comparing.

In another embodiment, there is provided, an authentication integrated circuit (IC) for use in a replaceable accessory, the replaceable accessory for authenticated communication with a host device, the authentication IC including: a processor for executing authentication commands received from the host device; and a memory for storing an authentication certificate and a certificate revocation list, wherein the certificate revocation list being a subset of a master revocation list provided by a certificate authority, the subset of the master revocation list updates a certificate revocation list in the host device when the host device authenticates the replaceable accessory. The memory may be characterized as being a non-volatile memory. The subset of the master revocation list is signed with a signature that binds the subset to one or more values of the certificate in the replaceable accessory. The replaceable accessory may include one of either a printer ink replacement cartridge, an electronic cigarette replacement cartridge, a beverage pod, a replacement filter element for a filtering apparatus, a sensor for a medical device, a refill cartridge for a medicine delivery system, a battery, a battery charger, and other replaceable accessory connected to and used by a longer lasting host device. The processor may be further characterized as being a finite state machine.

In yet another embodiment, there is provided, in a system comprising a host device and a plurality of replaceable accessories, a method for updating a revocation list in the host device, the method including: storing an authentication certificate in each replaceable accessory of the plurality of replaceable accessories; storing a subset of a master revocation list in each of the plurality of replaceable accessories; establishing communication between the host device and a replaceable accessory of the plurality of replaceable accessories; determining that an authentication certificate of the replacement accessory is not on the revocation list of the host device; verifying, by the host device, the authentication certificate of the replaceable accessory; verifying, by the host device, a signature of the subset of the master revocation list; validating that the signature is bound to a value of the authentication certificate in the authentication device; comparing, by the host device, the subset of the master revocation list with the revocation list of the host device; determining, by the host device, that the subset of the master revocation list includes a new entry, the new entry different from any entry of the revocation list of the host device; and merging the new entry with the revocation list of the host device. Storing the subset of a master revocation list in each of the plurality of replaceable accessories may further include storing the subset of the master revocation list in a memory location of an authentication integrated circuit in each of the plurality of replaceable accessories. The method may further include storing the subset of the master revocation with a certificate signature in the memory location, wherein the subset may be bound to the certificate signature. The replaceable accessory may include one of either a printer ink/toner replacement cartridge, a 3D printer filament cartridge/spool, an electronic cigarette replacement cartridge, a beverage pod, a replacement filter element for a filtering apparatus, a sensor for a medical device, a refill cartridge for a medicine delivery system, a battery, and a battery charger, and other replaceable accessory connected to and used by a longer lasting host device. The method may further include verifying a revocation list signature to establish the authenticity of the subset of the master revocation list prior to the step of comparing.

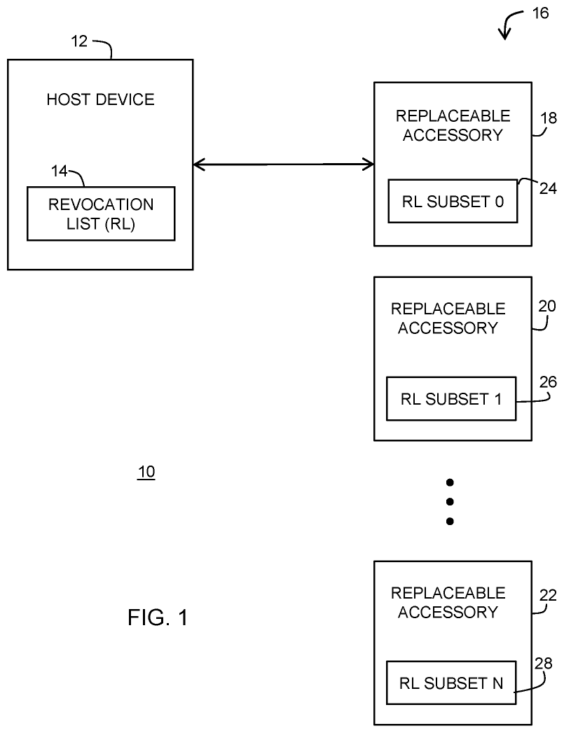

FIG. 1 illustrates system 10 in accordance with an embodiment. System 10 includes a host device 12 and a plurality of replaceable accessories 16. Host device 12 includes a stored certificate revocation list (RL) 14. Host device 12 may be any type of device that uses replaceable accessories. For example, host device 12 may be a printer, an electronic cigarette, a beverage pod, a filtering apparatus for filtering particles from a liquid or a gas, a medical device, etc. Typically, the host device has limited resources including limited or no access to networking and may not have access to a real-time clock. The plurality of replaceable accessories 16 includes representative replacement accessories 18, 20, and 22. The replaceable accessories may be, for example, a printer ink/toner replacement cartridge, a 3D printer filament cartridge/spool, an electronic cigarette replacement cartridge, a beverage pod, a replacement filter element for a filtering apparatus, a sensor for a medical device, a refill cartridge for a medicine delivery system, a battery, a battery charger, or any other replaceable object which is connected to and used by a longer lasting host device. Replaceable accessory 18 includes a revocation list subset 0 (RL SUBSET 0) stored in a memory location 24. Replaceable accessory 20 includes revocation list subset 1 (RL SUBSET 1) stored in a memory location 26. Replaceable accessor 22 includes revocation list subset N (RL SUBSET N) stored in a memory location 28. Variable N can be any number. The RL subsets are portions of a master RL that is created and updated by certificate authorities. Together, the RL subsets may provide the entire master RL for updating by the host device, one subset at a time, as the replaceable accessories are consumed. The certificate authority may be, for example, the system manufacturer or IC manufacturer.

The certificate revocation list includes a plurality of entries identifying replaceable accessories that are no longer allowed to be connected to a host device. There are various reasons why an accessory may longer be allowed to connect to a host device. For example, the accessory may be a counterfeit accessory using a stolen secret key. Theft of accessories or authentication ICs may also occur. Also, any flaws or defects such as security weaknesses may be found embedded in software or in hardware of the accessory. As compromised or illegitimate accessories or authentication ICs are discovered, the RL in the devices needs to be updated to identify the new threats to the host device. As stated above, the master certificate RL may be created and updated by certificate authorities. A certificate authority may be the system manufacturer of the host device and the replaceable accessories, or a proxy designated by the manufacturer. Alternately, the certificate authority may the manufacturer of the authentication IC implemented in the replaceable accessories. A certificate RL may also be known as a black list.

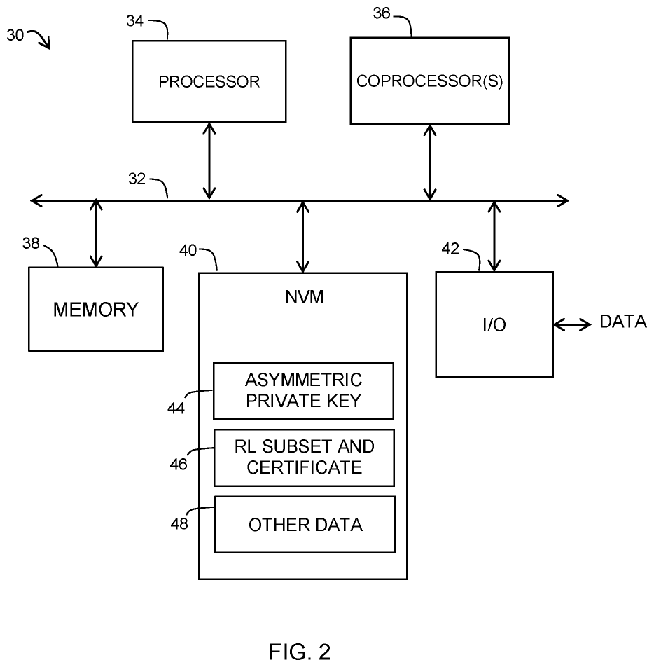

Each of the plurality of replaceable accessories 16 in FIG. 1 includes an authentication IC (shown in FIG. 2). Generally, the authentication IC provides security for host device 12 by authenticating the replaceable accessory when the replaceable accessory is first connected to host device 12. When connected, the replaceable accessory is authenticated. After successful authentication, host device 12 compares the entries in the RL subset stored in the authentication IC with the RL in host device 12 and any new RL entries are added to the RL of host device 12. As illustrated in FIG. 1, in some embodiments, only one of the replaceable accessories is connected to host device 12 at a time. In some embodiments, multiple replaceable accessories may be connected to host device 12 at the same time, such as a color ink jet printer that uses multiple cartridges to provide different colors. When the replaceable accessory is used up, it may be disposed of, or recycled, and another replaceable accessory is connected to host device 12. Because of its specialized role, the authentication IC has limited resources, e.g., only a relatively small amount of memory. The certificate RL subsets shown in the replaceable accessories of FIG. 1 are portions of a master certificate RL. As new replaceable accessories are connected to host device 12, the RL in the host device is updated one RL subset at a time.

Using this approach to update an RL of a host device allows for the offline distribution of a relatively large number of RL entries by dividing a master list of revocation entries into smaller subsets and storing each subset in the limited size non-volatile memory of the replaceable accessories. Furthermore, using a round-robin or alternative mixing approach including weighing the frequency of revocation entries based on urgency may be used during provisioning of the authentication IC to insure a more beneficial distribution of these subsets in replaceable accessories. As older host devices may be updated with new entries as newer accessories are connected, the newer accessories may obtain better coverage for the identification of counterfeit accessories.

FIG. 2 illustrates, in block diagram form, authentication IC 30 of one of the replaceable accessories 18, 20, and 22 of the system of FIG. 1 in accordance with an embodiment. Authentication IC 30 is implemented on a semiconductor substrate using conventional semiconductor processing technology. In other embodiments, IC 30 may be implemented on more than one IC. Generally, authentication IC 30 includes one or more asymmetric private keys and is issued a corresponding certificate by the certificate authority. The certificate is used to provide authentication as to the legitimacy of an entity (replaceable accessory) to a separate verifier entity (host device) via private key operations by the verifier. The verifier first validates the entity's certificate using public keys. Then, the verifier and uses an unknown (e.g., randomized) value to construct a challenge on which the entity performs a secret/private key operation, such as for example, a digital signature or key agreement. The verifier validates private key operation using the public key in the entity's certificate.

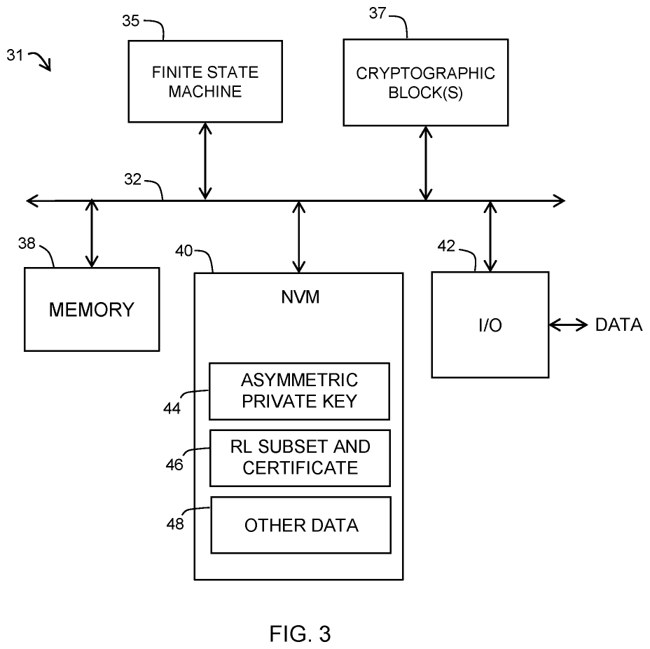

Authentication IC 30 includes bus 32. Bus 32 may be any kind of conventional bus for communicating data and/or control signals between the blocks connected to bus 32. Connected to bus 32 is processor 34, coprocessor 36, memory 38, non-volatile memory (NVM) 40, and input/output (I/O) circuits 42. Processor 34 may be any hardware device capable of executing instructions stored in, e.g., memory 38 or NVM 40. For example, processor 34 may be a microprocessor, field programmable gate array (FPGA), application-specific integrated circuit (ASIC), finite state machine (FSM) as illustrated in FIG. 3, or similar device. Processor 34 may have multiple processing cores. Also, processor 34 may be implemented in a secure hardware element and may have some anti-tamper protection.

Coprocessor 36, if present, may be the same as processor 34 or different. In one embodiment, coprocessor 36 may provide authentication or cryptographic processing such as encryption, decryption, or verification for securing the replaceable accessory as illustrated in FIG. 3.

Memory 38 may be any kind of memory, such as for example, L1, L2, or L3 cache or system memory. Memory 38 may be used to store instructions for execution by a processor, for example, processor 34 or coprocessor 36. Memory 38 may be implemented on IC 30 or may be implemented on a separate IC. Memory 38 may include volatile memory such as flip-flops, static random-access memory (SRAM) or dynamic RAM (DRAM), or may include NVM such as flash memory, read only memory (ROM), or other volatile or non-volatile memory. Also, memory 38 may be implemented in a secure hardware element. Alternately, memory 38 may be a hard drive connected to IC 30.

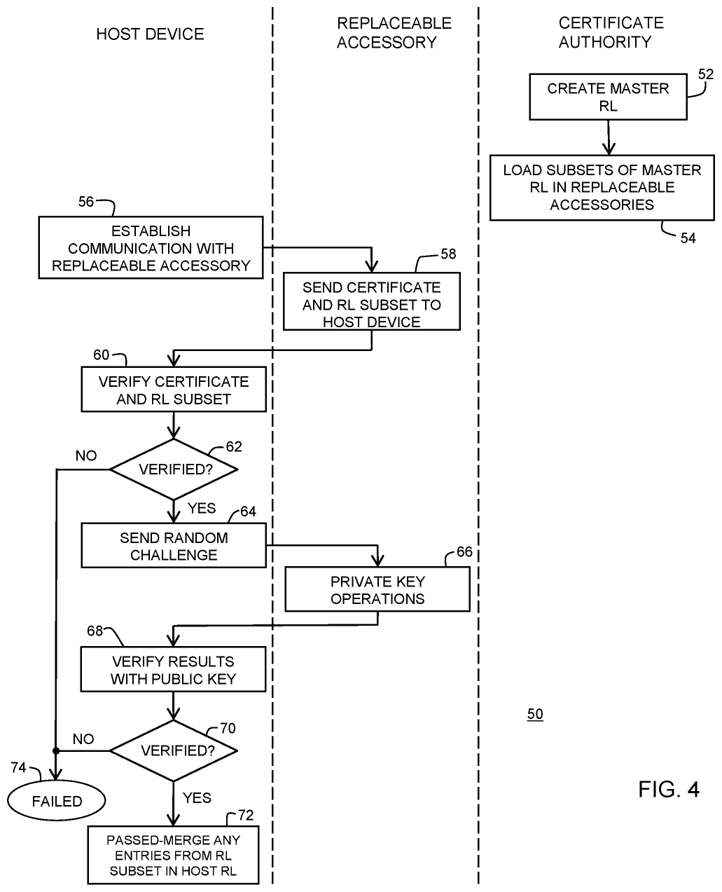

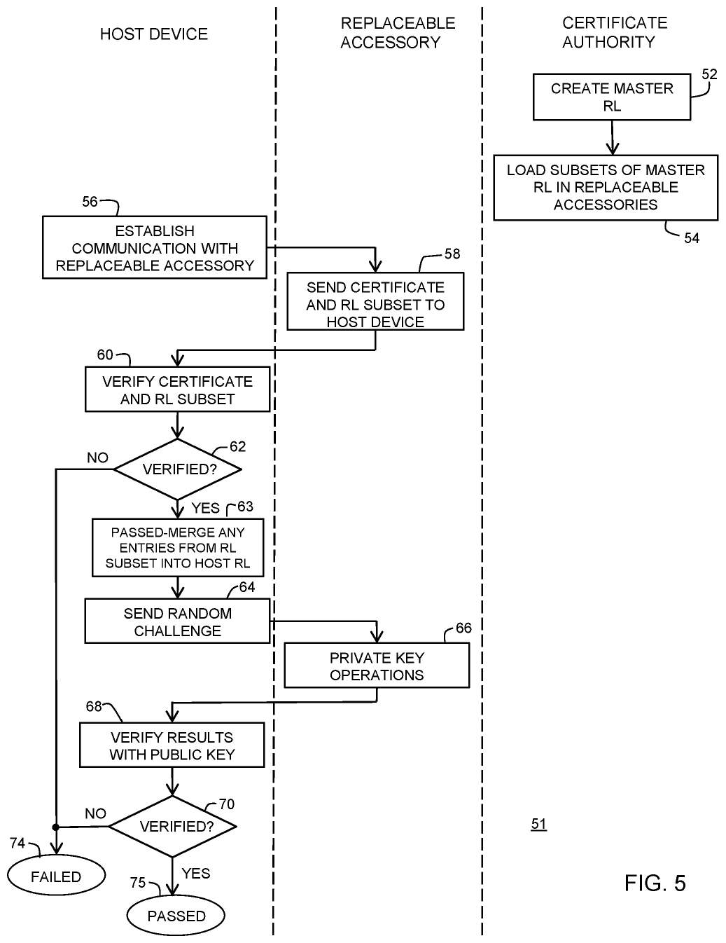

Non-volatile memory 40 is a conventional NVM such as, e.g., flash memory, EEPROM (electrically erasable programmable read only memory), read only memory (ROM), or other volatile or non-volatile memory. In one embodiment, NVM 40 is used to store an asymmetric private key in a memory location 44 for use in an asymmetric cryptographic algorithm, such as for example, elliptic curve cryptography, RSA (Rivest-Shamir-Adleman), digital signature algorithm (DSA), or Diffie-Hellman key exchange. Also, NVM 40 is used to store an RL subset and certificate in a memory location 46. FIGS. 4 and 5 illustrate alternate embodiments for storing the RL subset and certificate, which are discussed below. In addition, NVM 40 may be used to store other data in a memory location 48. Memory 40 may be implemented in a secure hardware element and may have some anti-tamper protection such as encryption and integrity checking.

FIG. 3 illustrates, in block diagram form, authentication IC 31 of a replaceable accessory of the system of FIG. 1 in accordance with another embodiment. Authentication IC 31 is the same as authentication IC 30 except that processor 34 has been replaced with FSM 35 and coprocessor 36 is replaced with one or more cryptographic blocks 37.

FIG. 4 illustrates a sequence diagram of a method 50 for updating revocation list 14 stored in host device 12 of system 10 in accordance with an embodiment. FIG. 4 illustrates a host device environment, a replaceable accessory environment, and a certificate authority environment separated by dashed lines. Method 50 begins at step 52. At step 52, the certificate authority creates a master RL. The master RL is a blacklisting of a single certificate or a group of certificates that have been declared untrustworthy. This master RL is updated periodically as new counterfeited, stolen, or compromised replacement accessories are discovered. In one embodiment, the certificate authority may be the manufacturer of system 10. In another embodiment, the certificate authority may the manufacturer of the authentication IC 30. At step 54, the master RL is divided into subsets of RL entries. The number of entries in a subset, and the number of subsets, may depend on the amount of available memory space in NVM 40 (FIG. 2 or FIG. 3). As mentioned above, the memory resources of authentication IC 30 are limited. The RL subsets should be sized to fit within the available memory space. During manufacturing, the certificate authority loads the RL subsets in the replaceable accessories, where one RL subset is loaded in the memory of one replaceable accessory. Typically, a host device is packaged for sale with the plurality of replaceable accessories. Preferably, each replaceable accessory includes a different RL subset of the master RL so that the number of master RL entries a host device processes is maximized

Step 56 is performed when a replaceable accessory is connected to a host device. At step 56, communication between the host device and the replaceable accessory is established. At step 58, the replaceable accessory sends its certificate, or certificate, and its RL subset to the host device. A certificate is a cryptographic object for an entity that has an asymmetric private key. The certificate includes a corresponding public key and digital signature. Also, the certificate may include other data relating to the identification and description of the entity. At step 60, the host device verifies a certificate signature of the replaceable accessory and a certificate signature of the replaceable accessory of the RL subset it received. The host device also verifies that the RL subset was signed with some value(s) from the signed certificate, such as public key, serial number, unique identifier, attribute(s), and/or extensions. The host device also checks if the replaceable accessory is on the RL of the host device. At decision step 62, it is determined if the certificate and RL subset are verified. If the certificate and RL subset are not verified, then the NO path is taken from step 62 to step 74 and the authentication fails, indicating to the host that the replaceable accessory is untrustworthy. If the certificate and RL subset are verified, then the YES path is taken from decision step 62 to step 64. At step 64, a randomized challenge is sent to the authentication IC of the replaceable accessory. At step 66, the authentication IC of the replaceable accessory performs private key operations on that challenge. The results of the private key operations are sent to the host device. At step 68, the host device verifies the results it received from the replaceable accessory using a public key from the certificate verified in step 60. At decision step 70, if the results received from the replaceable accessory are not verified, the verification fails, the NO path is taken to step 74 and the authentication fails, indicating to the host that the replaceable accessory is untrusted. If at decision step 70, the results are verified, then the YES path is taken to step 72. At step 72, the replaceable accessory is considered trustworthy. At any step after the YES path of step 62, the host device may compare the RL subset received from the replaceable accessory with the RL stored in the host device. Any new entry from the RL subset not in the host device is added to the RL of the host device. In this manner the RL of the host device is updated offline and without requiring a connection to a network. A new entry may reference a different black-listed entity or group of entities. Also, the new entry may reference the same entity or group of entities that is updated from a previous entry for that entity or group of entities. In addition, a new entry is an entry most recently presented and does not necessarily refer to when the new entry was created by the certificate authority.

FIG. 5 illustrates a sequence diagram of method 51 for updating a revocation list in a host device of the system of FIG. 1 in accordance with another embodiment. Method 51 is the same as method 50, except that the contents of step 72 in method 50 are moved to step 63 between the YES path of decision step 62 and step 64. Method 51 works the same as method 50 prior to step 63. If, at step 62, the certificate and RL subset are verified, the YES path is taken to step 63 and the verification passes, and any new entries of the RL subset of the replaceable accessory are merged into the master RL of the host. The method then proceeds to step 64 and continues as described above in the description of method 50 in FIG. 4.

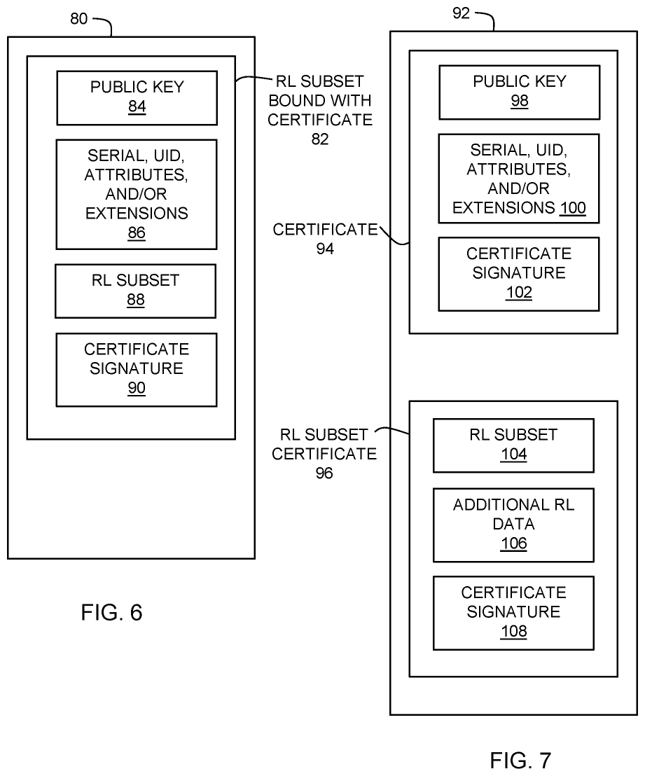

FIG. 6 illustrates a first embodiment for securing an RL subset in a non-volatile memory of IC 30. More specifically, FIG. 6 illustrates one format useful for binding an RL subset with a certificate signature in a memory location 80. In memory location 80, a public key 84, other data 86 such as serial number, unique identification (ID), attribute(s), extension(s), and RL subset 88 are bound with certificate signature 90 in certificate space 82. The embodiment of FIG. 6 provides the advantage of just requiring one certificate signature for both verification of the accessory's public data and verification of the RL subset.

FIG. 7 illustrates a second embodiment for securing an RL subset in a non-volatile memory of IC 30. In a memory location 92, public key 98, and other data such as serial number, UID, attributes, and/or extensions 100, are bound with certificate signature 102 in certificate space 94. Also, in memory location 92, RL subset 104 and additional RL data (optional) 106 are bound with a separate RL signature 108. An advantage of using separate signatures for device certificate and RL subset certificate is for legacy certificate support by the host and by third-parties, if any.

Various embodiments, or portions of the embodiments, may be implemented in hardware or as instructions on a non-transitory machine-readable storage medium including any mechanism for storing information in a form readable by a machine, such as a personal computer, laptop computer, file server, smart phone, or other computing device. The non-transitory machine-readable storage medium may include volatile and non-volatile memories such as read only memory (ROM), random access memory (RAM), magnetic disk storage media, optical storage medium, flash memory, and the like. The non-transitory machine-readable storage medium excludes transitory signals.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. In a system comprising a host device and a plurality of replaceable accessories, a method for updating a revocation list in the host device, the method comprising:
storing a certificate in each replaceable accessory of the plurality of replaceable accessories;
storing a subset of a master revocation list in each of the plurality of replaceable accessories;
establishing communication between the host device and a replaceable accessory of the plurality of replaceable accessories;
verifying, by the host device, the certificate of the replaceable accessory;
comparing, by the host device, the subset of the master revocation list with the revocation list of the host device;
verifying by the host device that the subset of the master revocation list has a legitimate signature and corresponds to the certificate;
determining, by the host device, that the subset of the master revocation list includes a new/updated entry; and
merging the new/updated entry with the revocation list of the host device.

2. The method of claim 1, wherein storing a subset of a master revocation list in each of the plurality of replaceable accessories further comprises storing the accessory certificate with the subset of the master revocation list in a memory location of an authentication integrated circuit in each of the plurality of replaceable accessories.

3. The method of claim 2, further comprising storing the subset of the master revocation with a signature in the memory location, wherein the subset is bound to one or more values of the certificate in the replaceable accessory.

4. The method of claim 1, wherein verifying, by the host device, a certificate of the replaceable accessory further comprises checking that the certificate is not listed on the revocation list of the host device.

5. The method of claim 1, wherein the replaceable accessory comprises one of either a printer ink/toner replacement cartridge, a 3D printer filament cartridge/spool, an electronic cigarette replacement cartridge, a beverage pod, a replacement filter element for a filtering apparatus, a sensor for a medical device, a refill cartridge for a medicine delivery system, a battery, a battery charger, and other replaceable accessory connected to and used by a longer lasting host device.

6. The method of claim 1, further comprising verifying a revocation list signature to establish the authenticity of the subset of the master revocation list prior to the step of comparing.

7. An authentication integrated circuit (IC) for use in a replaceable accessory, the replaceable accessory for authenticated communication with a host device, the authentication IC comprising:
a processor for executing authentication commands received from the host device; and
a memory for storing an authentication certificate and a certificate revocation list, wherein the certificate revocation list being a subset of a master revocation list provided by a certificate authority, the subset of the master revocation list updates a certificate revocation list in the host device when the host device authenticates the replaceable accessory.

8. The authentication IC of claim 7, wherein the memory is characterized as being a non-volatile memory.

9. The authentication IC of claim 7, wherein the subset of the master revocation list is signed with a signature that binds the subset to one or more values of the certificate in the replaceable accessory.

10. The authentication IC of claim 7, wherein the replaceable accessory comprises one of either a printer ink/toner replacement cartridge, a 3D printer filament cartridge/spool, an electronic cigarette replacement cartridge, a beverage pod, a replacement filter element for a filtering apparatus, a sensor for a medical device, a refill cartridge for a medicine delivery system, a battery, a battery charger, and other replaceable accessory connected to and used by a longer lasting host device.

11. The authentication IC of claim 7, wherein the processor is further characterized as being a finite state machine.

12. In a system comprising a host device and a plurality of replaceable accessories, a method for updating a revocation list in the host device, the method comprising:
storing an authentication certificate in each replaceable accessory of the plurality of replaceable accessories;
storing a subset of a master revocation list in each of the plurality of replaceable accessories;
establishing communication between the host device and a replaceable accessory of the plurality of replaceable accessories;
determining that the authentication certificate of the replacement accessory is not on the revocation list of the host device;
verifying, by the host device, the authentication certificate of the replaceable accessory;
verifying, by the host device, a signature of the subset of the master revocation list;
validating that the signature of the subset of the master revocation list is bound to one or more values of the authentication certificate in the authentication device;
comparing, by the host device, the subset of the master revocation list with the revocation list of the host device;
determining, by the host device, that the subset of the master revocation list includes a new/updated entry, the new/updated entry being different from any existing entry of the revocation list of the host device; and
merging the new/updated entry with the revocation list of the host device.

13. The method of claim 12, wherein storing the authentication certificate of the accessory further comprises storing a public key and a digital signature in a memory location of an authentication integrated circuit in each of the plurality of replaceable accessories.

14. The method of claim 12 wherein storing the subset of a master revocation list in each of the plurality of replaceable accessories further comprises storing the subset of the master revocation list in a memory location of an authentication integrated circuit in each of the plurality of replaceable accessories.

15. The method of claim 12, wherein the replaceable accessory comprises one of either a printer ink/toner replacement cartridge, a 3D printer filament cartridge/spool, an electronic cigarette replacement cartridge, a beverage pod, a replacement filter element for a filtering apparatus, a sensor for a medical device, a refill cartridge for a medicine delivery system, a battery, a battery charger, and other replaceable accessory connected to and used by a longer lasting host device.

16. The method of claim 12, further comprising verifying a revocation list signature to establish the authenticity of the subset of the master revocation list prior to the step of comparing.

17. The method of claim 12, further comprising verifying a certificate signature and verifying the signature of the subset of the master revocation list, to establish the authenticity of the subset of the master revocation list prior to the step of comparing that the subset of the master revocation list includes a new/updated entry.

18. The method of claim 17, wherein the certificate signature and the signature of the subset of the master revocation list are separate from each other.

19. The method of claim 17, wherein the certificate signature and the signature of the subset of the master revocation list are the same signature.
